(19) United States
(12) Patent Application Publication
(10) Pub. No.: US 2023/0259409 A1
(43) Pub. Date: Aug. 17, 2023

(54) CONTAINER SCHEDULING FOR EXECUTING DYNAMIC WORKLOADS IN CLOUD COMPUTING ENVIRONMENTS

(71) Applicant: IINFINITY STONES INC., Plano, TX (US)

(72) Inventors: Zhenwu Shi, Plano, TX (US); Xue Liu, Montreal, TX (US); Chenming Jiang, McKinney, TX (US)

(21) Appl. No.: 17/650,979

(22) Filed: Feb. 14, 2022

(51) Int. Cl. G06F 9/50; G06F 9/48

(52) U.S. Cl. CPC G06F 9/5088; G06F 9/4881

(57) ABSTRACT

Aspects of the disclosure provide for mechanisms for container scheduling in a computing system (e.g., a cloud computing environment). A method of the disclosure may include running a plurality of container groups on one or more node groups of a computing system, wherein each of the container groups comprises one or more containers configured to execute one of a plurality of jobs (containerized tasks); in view of a determination that a first job of the plurality of jobs is completed, removing, by a processing device, a first container group running on a first node of a first node group from the first node, wherein the first container group is configured to execute the first job; and migrating, by the processing device, one or more of the first plurality of container groups within the first node group to consolidate computing resources of the first node group.

### TECHNICAL FIELD

The implementations of the disclosure relate generally to computing systems and, more specifically, to container scheduling for executing dynamic workloads in a cloud computing environment.

### BACKGROUND

Containerization may refer to a form for operating system virtualization that enables multiple microservices or applications running in isolated user spaces. In a cloud computing system utilizing containerization techniques, a container may be a fully packaged and portable platform-independent computing environment that encapsulates all necessary dependencies. Multiple containers may be executed over a single host using the same shared operating system. Containerization may enable deployment of a microservice and/or application by starting the execution of a new container of the microservices.

### BRIEF DESCRIPTION OF THE DRAWINGS

The disclosure is illustrated by way of examples, and not by way of limitation, and may be more fully understood with references to the following detailed description when considered in connection with the figures, in which:

FIG. 1 is a block diagram of a computing system according to some implementations of the present disclosure;

FIG. 2 a block diagram of an example of a node according to some implementations of the disclosure;

FIG. 3 depicts a block diagram of a computing system operating some implementations of the present disclosure;

FIG. 4 is a flow diagram illustrating a process for scheduling containers in a computing system according to some implementations of the disclosure;

FIG. 5 is a flow diagram illustrating a process for consolidating computing resources for a node group of a computing system according to some implementations of the disclosure;

FIG. 6 is a flow diagram illustrating a process for scheduling a container group on a node group in a computer system according to some implementations of the disclosure;

FIG. 7 is a flow diagram illustrating a process for consolidating computing resources of a node group in a computing system according to some implementations of the disclosure;

FIG. 8 is a flow diagram illustrating a process for migrating a container group from an original node to a destination node according to some implementations of the disclosure; and

FIG. 9 is a block diagram illustrating one implementation of a computing system.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In accordance with one or more aspects of the present disclosure, methods for scheduling containers in a computing system are provided. The methods may include running a plurality of container groups on one or more node groups of a computing system, wherein each of the container groups comprises one or more containers configured to execute one of a plurality of jobs. The one or more node groups may include a first node group designated to host container groups of a first plurality of sizes and a second node group designated to host container groups of a second plurality of sizes. The plurality of container groups includes a first plurality of container groups running on the first node group. The methods may further include: in view of a determination that a first job of the plurality of jobs is completed, removing, by a processing device, a first container group running on a first node of the first node group from the first node, wherein the first container group is configured to execute the first job; and migrating, by the processing device, one or more of the first plurality of container groups within the first node group to consolidate computing resources of the first node group.

In some embodiments, migrating one or more of the first plurality of container groups may include migrating a second container group of the first plurality of container groups from the first node to a second node of the first node group, where a spare capacity of the first node is not greater than a spare capacity of the second node.

In some embodiments, migrating the second container group of the first plurality of container groups from the first node to the second node of the first node group may include: determining whether the spare capacity of the second node of the first node group is sufficient to host the second container group; and in response to determining that the spare capacity of the second node is sufficient to host the second container group, migrating the second container group from the first node to the second node. In some embodiments, determining that the spare capacity of the second node is sufficient to host the second container group may include determining that the second node is hosting a first number of container groups and that the first number is not greater than a threshold number. In some embodiments, migrating one or more of the first plurality of container groups may include: in response to determining that the spare capacity of the second node is not sufficient to host a third container group of the first plurality of container groups, determining whether a spare capacity of a third node of the first node group is sufficient to host the third container group; and migrating the third container group from the first node to the third node in response to determining that the spare capacity of the third node is sufficient to host the third container group. In some embodiments, migrating one or more of the first plurality of container groups within the first node group further may include: identifying the second node by ranking a first plurality of nodes of the first node group based on spare capacities of the first plurality of nodes.

In some embodiments, the methods may further include: removing the first node from the first node group in response to determining that the first node is empty. Each of the node groups is associated with one of a plurality of container sizes; and scheduling the plurality of container groups on one or more of the plurality of nodes based on sizes of the plurality of container groups and the plurality of container sizes.

In some embodiments, scheduling the plurality of container groups on one or more of the plurality of nodes based on the sizes of the plurality of container groups and the plurality of container sizes may include: scheduling the first container group on the first node in view that the first plurality of container sizes may include a size of the first container group and that the first node is unfilled.

In some embodiments, the methods may further include adding a new node to the second node group in view that a threshold number of container groups are running on each node of the first node group. In some embodiments, removing the first container group from the first node of the first node group may include releasing a first computing resource of the first node allocated to the first container group, where the computing resources of the first node group may include the released first computing resource.

According to one or more aspects of the present disclosure, systems for containers in a cloud computing environment are provided. The systems may include a memory, and a processing device operatively coupled to the memory. The processing device is to: run a plurality of container groups on one or more node groups of a computing system, wherein each of the container groups comprises one or more containers configured to execute one of a plurality of jobs, wherein the one or more node groups comprise a first node group designated to host container groups of a first plurality of container sizes and a second node group designated to host container groups of a second plurality of container sizes, and wherein the plurality of container groups comprises a first plurality of container groups running on the first node group; in view of a determination that a first job of the plurality of jobs is completed, remove, by a processing device, a first container group running on a first node of the first node group from the first node, wherein the first container group is configured to execute the first job; and migrate one or more of the first plurality of container groups within the first node group to consolidate computing resources of the first node group.

In some embodiments, to migrate one or more of the first plurality of container groups, the processing device is further to migrate a second container group of the first plurality of container groups from the first node to a second node of the first node group, wherein a spare capacity of the first node is not greater than a spare capacity of the second node.

In some embodiments, to migrate the second container group of the first plurality of container groups from the first node to the second node of the first node group, the processing device is further to: in response to determining that the spare capacity of the second node is sufficient to host the second container group, migrating the second container group from the first node to the second node.

In some embodiments, the processing device is to determine that the spare capacity of the second node is sufficient to host the second container group in response to determining that the second node is hosting a first number of container groups and that the first number is not greater than a threshold number.

In some embodiments, to migrate one or more of the first plurality of container groups, the processing device is further to: in response to determining that the spare capacity of the second node is not sufficient to host a third container group of the first plurality of container groups, determine whether a spare capacity of a third node of the first node group is sufficient to host the third container group, wherein the spare capacity of the second node is not greater than the spare capacity of the third node; and migrate the third container group from the first node to the third node in response to determining that the spare capacity of the third node is sufficient to host the third container group.

In some embodiments, to migrate one or more of the first plurality of container groups, the processing device is further to: identify the second node by ranking a first plurality of nodes running on the first node based on spare capacities of the first plurality of nodes; and sort the first plurality of container groups based on resource usages.

In some embodiments, the processing device is further to: remove the first node from the first node group in response to determining that the first node is empty.

In some embodiments, the processing device is further to: classify a plurality of nodes of the computing system into the one or more node groups, wherein each of the node groups is associated with one of a plurality of ranges of container sizes; and schedule the plurality of container groups on one or more of the plurality of nodes based on sizes of the plurality of container groups and the plurality of ranges of container sizes.

In accordance with one or more aspects of the present disclosure, a non-transitory machine-readable storage medium is provided. The non-transitory machine-readable storage medium includes instructions that. that, when accessed by a processing device, cause the processing device to: run a plurality of container groups on one or more node groups of a computing system, wherein each of the container groups comprises one or more containers configured to execute one of a plurality of jobs, wherein the one or more node groups comprise a first node group designated to host container groups of a first plurality of container sizes and a second node group designated to host container groups of a second plurality of container sizes, and wherein the plurality of container groups comprises a first plurality of container groups running on the first node group; in view of a determination that a first job of the plurality of jobs is completed, remove, by a processing device, a first container group running on a first node of the first node group from the first node, wherein the first container group is configured to execute the first job; and migrate, by the processing device, one or more of the first plurality of container groups within the first node group to consolidate computing resources of the first node group

### DETAILED DESCRIPTION

Aspects of the disclosure provide for mechanisms for container scheduling in cloud computing environments. A container may be an execution environment represented by an isolated virtualized user-space instance of an operating system. The user-space instance may be associated with a kernel instance which may be shared with other containers. Containers may be deployed to store software application code (e.g., a utility program such as a compiler) for performing operations of the software application code. The software application code may be stored and used to create containerized applications. A containerized applications may be released as a software product that can be executed as a self-contained application on physical or virtual machines in a cloud computing system.

Existing container scheduling systems may simplify the deployment of containerized applications on cloud services using Containers-as-a-Service (CaaS) techniques. For example, to schedule deployment of a container, a Kubernetes scheduler may filter out the available nodes in a cloud that do not meet certain requirements of the container. The Kubernetes scheduler may then score and rank the remaining candidate nodes using priorities (e.g., resource limits) to select an optimal node to execute the container. However, the existing container scheduling systems fail to provide mechanisms for scheduling workloads (e.g., applications or components of applications) that may dynamically arrive at or depart from the computing system (e.g., dynamic workloads that may arrive at or depart from a decentralized computing system (e.g., a blockchain system) due to increased gas fees, chain maintenance, version update, etc.). For example, although a native Kubernetes scheduler is designed to assign the container to the optimal node at a particular moment, the optimal node can change after the containers start running. The assignments of the optimal node may become inefficient due to the dynamic change of the workloads executed in a cloud computing environment due to a lack of knowledge of the arrival workload patterns by the container scheduler system. As a result, redundant nodes and computing resources may be allocated to the workloads, resulting in unnecessary resource costs. Furthermore, it might be desirable to consolidate the containers in view of the dynamic workload change (e.g., releasing and consolidating resources used by the workload that are terminated) utilizing container migration mechanisms. However, the existing container scheduling systems do not provide a resource consolidation scheme that may consolidate terminated jobs (e.g., containerized tasks) and/or containers while minimizing the costs of container migration (e.g., restarting and initializing the jobs in new containers).

Aspects of the disclosure address the above and other deficiencies of the existing container scheduling systems by providing mechanisms (e.g., systems, methods, machine-readable media, etc.) for scheduling deployment of containers in view of dynamic workloads executed in a computing system. To execute a workload including a plurality of jobs (e.g., containerized tasks), the mechanisms may schedule deployment of a plurality of container groups for executing the jobs. Each of the container groups may include one or more containers with shared storage and network resources. In some embodiments, each of the container groups may be configured to execute one of the jobs. A job of a given size (e.g., a certain resource demand, such as a CPU demand) may be executed by a container group having a container size corresponding to the size of the job (e.g., a container size equal to or greater than the size of the job).

To schedule the deployment of the container groups, the mechanisms may classify the container groups into a plurality of categories based on their container sizes. Each of the categories may correspond to one or more particular container sizes (e.g., a range of container sizes). The mechanisms may further classify a plurality of nodes (e.g., physical machines, virtual machines) of a computing system into a plurality of classes. Each of the classes may correspond to one of the ranges of container sizes. A class of the nodes (also referred to as a node group) may thus be designated to execute containers and/or container groups of the particular container sizes associated with the class. Each of the container groups may then be scheduled on one or more of the classified nodes based on the container sizes of the container groups. For example, a first node group may include one or more nodes designated to host containers and/or container groups with one or more first container sizes (e.g., a first range of container sizes). To schedule deployment of a first container group to execute a first job of a first size. the mechanisms described herein may schedule deployment of a first container group of a first container size to execute a first job on a first node of the first node group in view that the one or more first container sizes include the first container size.

The mechanisms may further manage the container groups running on the classified nodes and consolidate the computing resources of the nodes in view of dynamic workload changes. For example, the mechanisms may remove the first container group from the first node of the first node group upon completing the first job. The computing resources allocated to the first container group may then be released and allocated to existing and/or further workloads. The mechanisms may further migrate one or more container groups running on the first node to one or more other nodes of the first node group to consolidate the workloads and/or computing resources of the first node group. For example, the mechanisms may rank the container groups running on the first node by resource usages of the container groups. The mechanisms may then identify a second container group running on the first node for migration based on the ranking (e.g., by selecting the container group consuming the least resource). The mechanisms may migrate the second container group from the first node to a second node of the first node group. The spare capacity of the second node may be greater than the spare capacity of the first node. In some embodiments, the second node does not include a node that may host the second container group. In such embodiments, the mechanisms may migrate the second container group from the first node to a third node of the first node group. The spare capacity of the third node may be greater than the spare capacity of the second node. The mechanisms may perform container migration within the first node group in an iterative manner to migrate the container groups running on the first node to another node of the first node group. In some embodiments, the container groups running on the first node may be migrated in an order determined based on resource usages of the container groups. For example, after migrating the second container group, the mechanisms may migrate a third container group running on the first node to another node of the first node group that has a greater spare capacity than that of the first node. The third container group may consume more computing resources than the second container group. In some embodiments, the mechanisms may determine that one or more container groups are not to be migrated from the first node in view that no other node in the first node group may host the one or more container groups.

Accordingly, aspects of the present disclosure provide for scheduling mechanisms that can enhance cluster orchestrators by taking dynamic workloads into consideration when placing containers on a node of a computing system. The mechanisms may minimize the total number of used nodes for all active workloads running in the computing system and the migration costs associated with resource consolidation. As such, the mechanisms disclosed herein can improve resource utilization of a cloud computing environment.

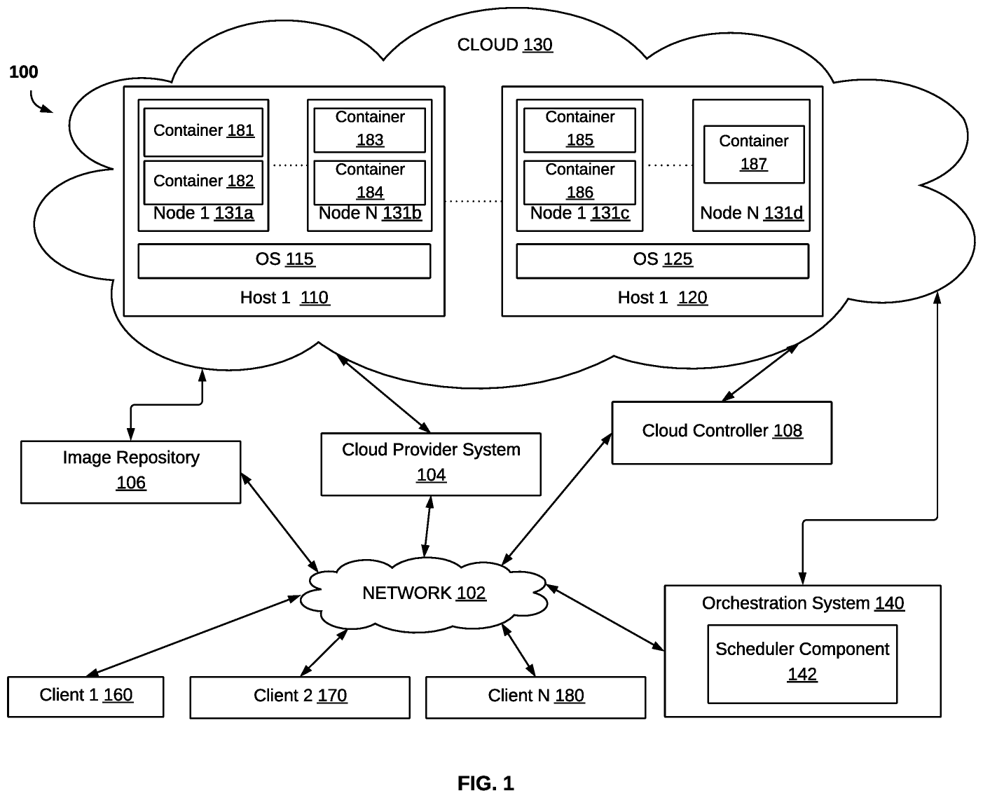

FIG. 1 is a block diagram of a computing system 100 in which implementations of the disclosure may operate. The computing system 100 may provide resources and services for the development and execution of containerized applications owned and/or managed by multiple users. The cloud computing system 100 may be implemented as part of a Containers-as-a-Service (CaaS) system, a Platform-as-a-Service (PaaS), a Blockchain-as-a-Service (BaaS) system, etc. In some embodiments, the cloud computing system 100 may be a decentralized computing system (e.g., a blockchain platform).

As illustrated, the computing system 100 may include a cloud-computing environment (“cloud”) 130 including one or more host machines (e.g., host 110, host 120, etc.). Each host machine 110, 120 may be a server computing system, a desktop computer, or any other computing device. Each host machine may host one or more nodes 131 that may execute applications and/or processes associated with the applications, such as nodes 131a, 131b, 131c, 131d, etc. Each node 131 may be any suitable machine that may provide the execution environment for an application and/or service. For example, a node 131 may be a physical machine, such as host 110, 120, etc. or one or more portions of host 110, 120. As another example, a node 131 may be a virtual machine (VM) that is hosted on a physical machine.

In some embodiments, a host may include an operating system (e.g., OS 115, 125) with one or more user space programs. The operating system may include software programs that can use the underlying computing device to perform computing tasks, such as a kernel comprising one or more kernel space programs (e.g., memory drivers, network drivers, file system drivers, etc.) for interacting with virtual or actual hardware devices. User space programs may include programs that are capable of being executed by the operating system and in one example may be an application program for interacting with a user.

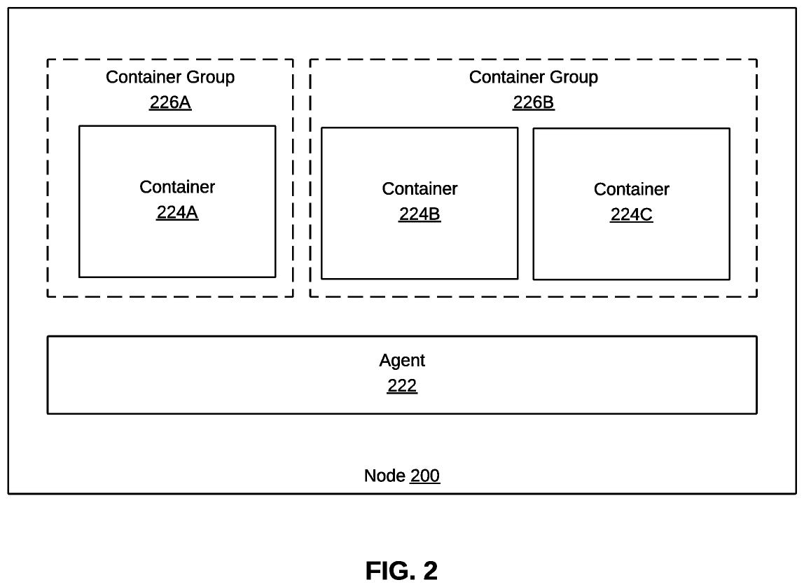

In some embodiments, each node 131 can host one or more containers (containers 181, 182, 183, 184, 185, 186, 187, etc.). Each of the containers may be a secure process space on a node 131 to execute one or more functionalities of an application and/or a service. In some implementations, a container is established at the nodes 131 with access to certain resources of the underlying node, including memory, storage, processing resources, etc. A container may serve as an interface between a host machine and a software application. The software application may include one or more related processes and may provide a certain service (e.g., an HTTP server, a database server, etc.). In some embodiments, one or more containers running on the host 110 and/or 120 may form a container group. The container group may include one or more containers with shared storage and network resources. The containers in the container group may also share a specification for how to run the containers. The containers in the container groups may reside at one or more nodes. In some embodiments, each node 131 may be and/or include a node 200 of FIG. 2.

In some implementations, the host machines 110, 120 may be in a data center. Users can interact with applications executing on nodes 131 using client computing systems, such as client devices 160, 170, and 180, via corresponding web browser applications and/or any other suitable applications. In some implementations, the applications may be hosted directly on hosts 1 through N 110, 120 without the use of VMs (e.g., a “bare metal” implementation). In such an implementation, the hosts may be referred to as “nodes.”

Client devices 160, 170, and 180 may be connected to hosts 110, 120 in cloud 130 and the cloud provider system 104 via a network 102, which may be a private network (e.g., a local area network (LAN), a wide area network (WAN), intranet, or other similar private networks) or a public network (e.g., the Internet). Each client device 160, 170, 180 may be a mobile device, a PDA, a laptop, a desktop computer, a tablet computing device, a server device, or any other computing device.

In one implementation, a cloud provider system 104 is communicatively coupled to a cloud controller 108 via network 102. The cloud provider system 104 and the cloud controller 108 may include one or more machines such as server computers, desktop computers, etc. The cloud controller 108 may reside on one or more machines (e.g., server computers, desktop computers, etc.) and may manage the execution of applications in cloud 130. In some implementations, cloud controller 108 may receive commands from orchestration system 140. In view of these commands, cloud controller 108 may provide data (e.g., pre-generated images) associated with different applications to the cloud provider system 104. In some implementations, the data may be provided to the cloud provider system 104 and stored in an image repository 106, in an image repository located on each host 110, 120 (not shown), or in an image repository located on each node 131 (not shown). This data may be used for the execution of applications for a multi-tenant PaaS system managed by orchestration system 140.

In some implementations, the data associated with the application may include data used for the execution of one or more containers that include application images built from pre-existing application components and source code of users managing the application. An image may include data representing executables and files of the application used to deploy functionality for a runtime instance of the application. In some implementations, the image can be built using suitable containerization technologies.

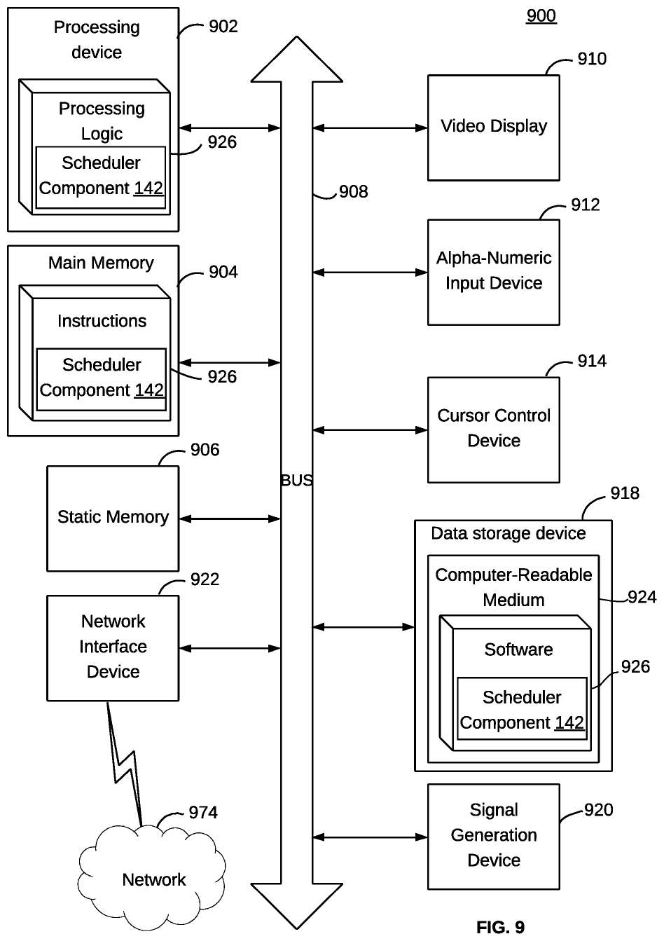

Orchestration system 140 can include one or more computing devices (e.g., a computing device as shown in FIG. 9). Orchestration system 140 can implement an application programming interface to facilitate deployment, scaling, and/or management of containerized applications (e.g., blockchain applications utilizing PoS mechanisms). Orchestration system 140 may provide management and orchestration functions for running and managing workloads in system 100. A workload may be one or more applications and/or one or more components of an application (e.g., one or more services). Running a workload may involve running one or more containers to execute one or more jobs of the workload. Each of the jobs may be a containerized task that may provide one or more functionalities of the application.

In some embodiments, the workloads handled by orchestration system 140 may include one or more blockchain applications utilizing blockchain techniques. A blockchain may be a continuously growing chain of blocks that works in a decentralized manner and a consensus mechanism is carried out to guarantee that all nodes on a network are synchronized, and its transactions are legitimate, and thus ensures the integrity of the entire blockchain. A blockchain application deployed on the computing system 100 may utilize one or more suitable blockchain consensus algorithms, such as a proof of stake (PoS) algorithm that may select validators in proportion to their quantity of holdings in the associated cryptocurrency, a proof of work (PoW) algorithm that requires a party to prove to the verifiers that it has expended a certain amount of computational effort, etc.

In some embodiments, the workloads managed by orchestration system 140 may include one or more workloads with known arrival workload patterns (also referred to as the “offline workloads”). For example, orchestration system 140 may know resource demands of an offline workload in advance. Examples of the offline workloads may include long-term services, such as the deployment of a blockchain, validating blockchain nodes periodically, removing blockchain nodes periodically, etc. The workloads managed by orchestration system 140 may further include one or more workloads with unknown workload patterns (also referred to as the “online” workloads). For example, orchestration system 140 does not know resource demands of an online workload in advance. Examples of the online workloads may include short-term services, such as a version update for selected nodes in a blockchain.

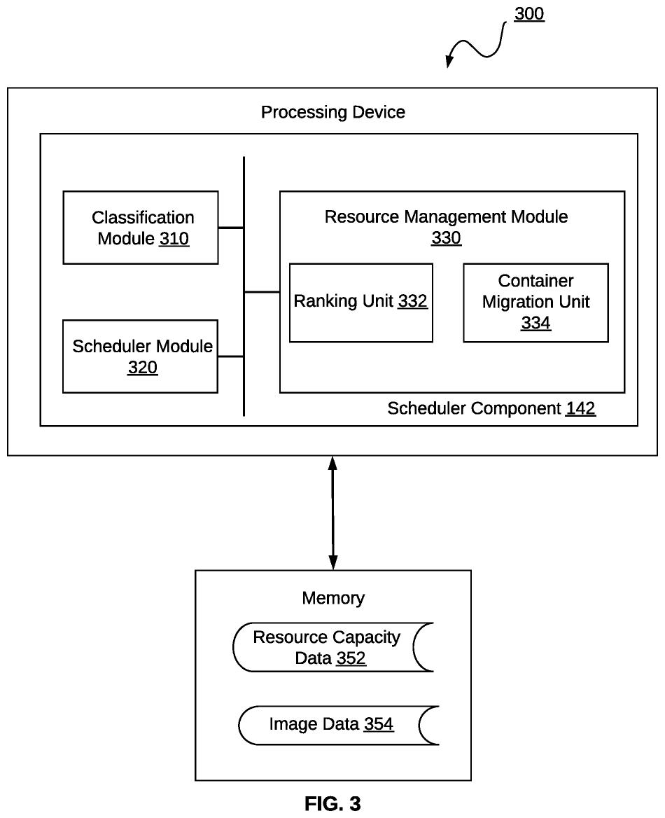

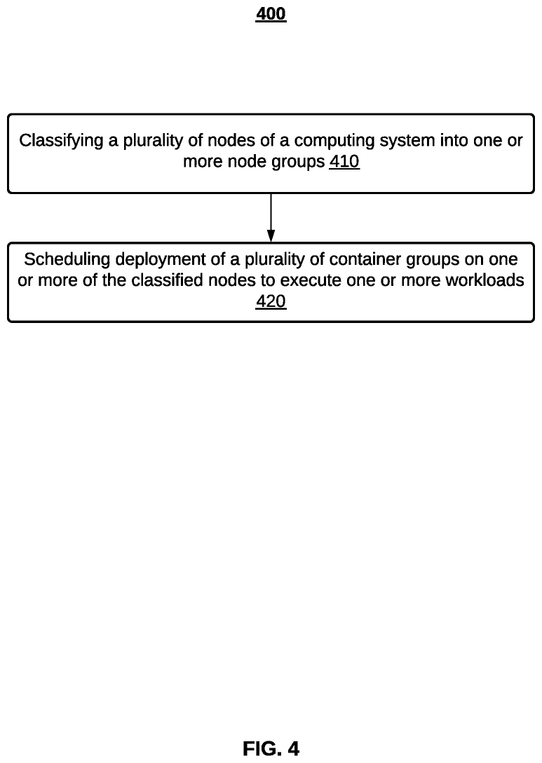

As illustrated in FIG. 1, orchestration system 140 may include a scheduler component 142 for scheduling workloads. In some embodiments, the scheduler component 142 may include one or more components described in connection with FIG. 3 and may implement one or more methods described in connection with FIGS. 4-8.

As an example, scheduler component 142 may schedule a workload on one or more nodes of computing system 100 by deploying one or more containers on the nodes to run the workload. In some embodiments, each of the containers may be configured to run one or more jobs of the workload. More particularly, for example, scheduler component 142 may build one or more container images for running the workload and may create and run one or more containers using the container images (e.g., by instructing one or more nodes 131 to instantiate one or more containers from the container image(s)).

In some embodiments, to schedule a workload including a plurality of jobs on one or more nodes of computing system 100, scheduler component 142 may place the jobs of the workload on suitable nodes of computing system 100 to minimize the total cost of the nodes used for running the workload. For example, scheduler component 142 may determine, for each of the jobs, a resource demand representative of an amount of computing resource required to run the job. Examples of the computing resource may include processing resources (e.g., CPU resources), memory resources, network resources, etc. In one implementation, the resource demand may be provided by a user requesting the execution of the workload. In another implementation, the resource demand may be estimated by scheduler component 142 based on the specific job to be executed (e.g., computing π to 1000 places and printing it out). Scheduler component 142 may then determine whether the workload is to be scheduled on a specific node of computing system 100 based on the following formulas.

$${min}_{{x}_{ij}} K = {\sum }_{j = 1}^{n} {p}_{j} {y}_{j} , \qquad ( 1 )$$

$$s . t . K \geq 1 ,$$

$${\sum }_{i ∈ I} s ( i ) {x}_{ij} \leq {B}_{j} {y}_{j} , ∀ j ∈ \{ 1 , … , n \} ,$$

$${\sum }_{j = 1}^{n} {x}_{ij} = 1 , ∀ i ∈ I ,$$

$${y}_{i} ∈ \{ 0 , 1 \} , ∀ y ∈ \{ 1 , … , n \} ,$$

$${x}_{ij} ∈ \{ 0 , 1 \} , ∀ i ∈ I , ∀ y ∈ \{ 1 , … , n \} .$$

In formulas 1, Xᵢⱼ is a decision variable that denotes if job i is to be placed on node j. Xᵢⱼ may have a first value (e.g., “1”) in some embodiments in which job i is determined to be scheduled on node j. Xᵢⱼ may have a second value (e.g., “0”) in some embodiments in which job i is not to be scheduled on node j. Bⱼ is a capacity parameter representative of the computing capacity of node j (e.g., an available computing resource of node j). Pⱼ is a cost parameter representative of the cost of node j. K denotes the total cost of all the used worker nodes to schedule the workload W.

In some embodiments, computing system 100 may include multiple nodes of the same computing capacity and the same cost. In such embodiments, scheduler component 142 may schedule a workload by minimizing the number of the nodes used to host the containers and/or container groups for executing the workloads. For example, scheduler component 142 may schedule workload W based on the following formula.

$${min}_{{x}_{ij}} K = {\sum }_{j = 1}^{n} {y}_{j} , \qquad ( 2 )$$

$$s . t . K \geq 1 ,$$

$${\sum }_{i ∈ I} s ( i ) {x}_{ij} \leq {By}_{j} , ∀ j ∈ \{ 1 , … , n \} ,$$

$${\sum }_{j = 1}^{n} {x}_{ij} = 1 , ∀ i ∈ I ,$$

$${y}_{i} ∈ \{ 0 , 1 \} , ∀ y ∈ \{ 1 , … , n \} ,$$

$${x}_{ij} ∈ \{ 0 , 1 \} , ∀ i ∈ I , ∀ y ∈ \{ 1 , … , n \} .$$

In some embodiments, scheduler component 142 may schedule offline workloads based on formulas 1 and/or 2.

In some embodiments, scheduler component 142 may schedule containers and/or container groups for executing one or more workloads based on sizes of the containers and/or container groups. A size of a container or container group (also referred to herein as the “container size”) may correspond to an amount of computing resource allocated to the container or container group. The computing resources may be and/or include, for example, processing resources, storage resources, network resources, etc. In some embodiments, scheduler component 142 may classify the containers and/or container groups to be scheduled into one or more categories based on the container sizes of the containers and/or container groups. Each of the categories may correspond to one or more particular container sizes (e.g., a range of container sizes). The container sizes may be categorized in any suitable manner. For example, the container sizes may be partitioned into a plurality of ranges of container sizes (e.g., by partitioning the container sizes harmonically into M pieces). Each of the plurality of ranges of container sizes may be associated with a respective category of container sizes.

Scheduler component 142 may further classify a plurality of nodes of computing system 100 into a plurality of classes. Each of the classes is associated with one or more particular container sizes (e.g., a range of container sizes) and corresponds to a respective category of the container sizes. The nodes classified into a particular class may be designated to run containers and/or containers groups of the particular container sizes associated with the particular class. Each class of nodes is also referred to herein as a node group. As such, the nodes in a node group are designated to host containers and/or container groups of particular container sizes associated with the node group.

Scheduler component 142 may then schedule containers and/or container groups on the node groups based on sizes of the containers and/or container groups and the container sizes associated with the node groups. For example, to schedule a container group of a given size, scheduler component 142 may identify one or more node groups that are designated to host container groups of the given size. In some embodiments, to schedule a first container group of a first size, scheduler component 142 may identify a first node group as a node group that may host the first container group in view of a determination that the first node group is associated with a first plurality of container sizes and that the first plurality of container sizes includes the given size. In some embodiments, scheduler component 142 may identify the first node group in view of a determination that the first container group is classified into the first category corresponding to the first class.

Scheduler component 142 may further identify a node of the first node group that is unfilled and may schedule the container group on the identified node. In some embodiments, scheduler component 142 may determine that a node is filled in view of a determination that the node hosts a threshold number of containers and/or container groups. Similarly, scheduler component 142 may determine that a node is unfilled in view of a determination that the number of containers and/or container groups hosted by the node is not greater than the threshold number. In another implementation, scheduler component 142 may determine that a node is filled in view of a determination that the spare capacity (e.g., available computing resources) of the node is not less than a threshold spare capacity. Scheduler component 142 may determine that a node is unfilled in view of a determination that the spare capacity of the node is not greater than the threshold spare capacity.

In some embodiments, scheduler component 142 may monitor the resources of each node group and manage the node groups so that each node group includes at least one unfilled node. For example, scheduler component 142 may add a new node to a node group in response to determining that each node of the node group is filled (e.g., hosting a threshold number of containers and/or container groups).

In some embodiments, scheduler component 142 may schedule workloads on nodes 131 by implementing algorithm 1 shown below.

Algorithm 1

```
Initialization:
Initialize the node Iⱼ // j = 1 → M
bⱼ = 0
Wⱼ.add(Iⱼ)
for j = 1, ..., M − 1 do
  for i = 1, ..., n do
    $if s ( i ) ∈ ( \frac{B}{j + 1} , \frac{B}{j} ] then$
      place s(i) into the current Iⱼ worker node (bin),
      if Iⱼ cannot hold s(i), i.e. filled then
        bⱼ = bⱼ + 1 and allocate a new Iⱼ node for s(i)
        Wⱼ.add(Iⱼ)
      end if
    $else if s ( i ) ∈ ( 0 , \frac{B}{M} ] then$
      //run next fit for s(i)
      if there is room for s(i) in the current I_{M} node.
      place it.
      if not, b_{M} = b_{M} + 1, place s(i) in a new I_{M} node
      W_{M}.add(I_{M})
    end if
  end for
end for
```

In algorithm 1, n is a parameter that denotes the total number of jobs to be scheduled. S(i) is the parameter representative of the job size of each job i. M is a parameter that denotes the number of categories into which the jobs are divided according to the job sizes.

In some embodiments, scheduler component 142 may schedule dynamic workloads including both workloads that arrive at computing system 100 (also referred to as the “arriving workloads”) at a particular time and workloads that depart from computing system 100 (also referred to as the “departing workloads”) at the particular time. The particular time may be, for example, a particular time instant, a time period, etc. Scheduler component 142 may schedule the arriving workloads as described above. Scheduler component 142 may further reschedule the workloads running on computing system 100 and consolidate computing resources of the node groups in view of departures of the departing workloads from computing system 100.

In some embodiments, scheduler component 142 may reschedule the workloads running on computing system 100 to reduce the number of used nodes in computing system 100 and/or the computing resource consumed by the used nodes. For example, scheduler component 142 may schedule a workload on a first node in a first node group by deploying one or more container groups. Upon completion of the workload, scheduler component 142 may remove one or more container groups executing the workload from the first node. In some embodiments, a first container group running on the first node may be configured to execute a first job of the workload. Scheduler component 142 may remove the first container group from the first node in view of the completion of the first job. The computing resource of the first node allocated to the first container group may be released and become part of the available computing resource of the first node. For example, the released computing resource may be allocated to one or more containers and/or container groups running an arriving workload.

Scheduler component 142 may further consolidate the workloads running on the node groups in view of the departures of the departing workloads. For example, scheduler component 142 may perform container migration within a node group to consolidate computing resources of the node group. More particularly, for example, scheduler component 142 may migrate one or more containers and/or container groups running on the first node to one or more other nodes of the first node group. To migrate a container or container group from the first node (the “original node”) to a destination node, scheduler component 142 may identify the destination node by identifying a node in the first node group that has more spare capacity than the first node. In some embodiments, scheduler component 142 may migrate the container from the first node to the destination node in view that the destination node has sufficient computing resources to host the container or container group (e.g., by determining that the next node is unfilled). In some embodiments in which the currently identified destination node does not have sufficient computing resources to host the container or container group, scheduler component 142 may identify a next node of the first node group as the destination node to migrate the container or container group. Scheduler component 142 may perform container migration as described herein until all the containers and/or container groups in the first node are migrated. In some embodiments, scheduler component 142 does not migrate a container/container group running on the first node in view that no node in the first node group other than the first node has sufficient computing resources to host the container and/or container group.

In some embodiments, rescheduling the containers may involve performing one or more operations as described in connection with Algorithm 2 below.

Algorithm 2

```
Input: Wⱼ //j = 1 → M, the output of Algorithm 1
Output: allocated Wⱼ
for each Iⱼ in Wⱼ do
  if job ϵIⱼ && job is finished then
    delete job;
  end if
end for
Wⱼ′ = Sort (Wⱼ) // Sort Iⱼ in Wⱼ based on total usage
descending order
while Job allocation is not finished do
  I_{L} := I_{b}_{ⱼ} the last node in Wⱼ′
  Sort jobs in I_{L} based on usage in descending order
  LOOP: sₗ := the last job in node I_{L}
  if I_{K} (k = 1, ..., bⱼ₋₁) has room for sₗ then
    allocate sₗ in Iₖ
    if I_{L} is not empty then
      goto LOOP
    else
      delete I_{b}_{ⱼ}
      bⱼ = bⱼ₋₁
    end if
  else
    Job allocation is finished //Wⱼ does not change
  end if
end while
```

In algorithm 2, Wⱼ′ is a parameter that denotes the node group with type j node(s) after the assortment based on total usage of computing resource of each type j node. I_{L} denotes the last node in Wⱼ′ and si denotes the last job in node I_{L}. In some embodiments, scheduler component 142 may schedule online workloads based on algorithm 1 and/or 2.

While various implementations are described in terms of the environment described above, the facility may be implemented in a variety of other environments including a single, monolithic computing system, as well as various other combinations of computing systems or similar devices connected in various ways. For example, the scheduler component 142 may be running on a node 131 or may execute external to cloud 130 on a separate server device.

FIG. 2 is a block diagram of an example 200 of a node according to some embodiments of the present disclosure. Node 200 may provide run-time environments for one or more containers. In some embodiments, node 200 may include a computing device with one or more processors communicatively coupled to memory devices and input/output (I/O) devices, as described in more details below in conjunction with FIG. 9.

Node 200 may be and/or include a physical machine, a virtual machine, etc. Node 200 may provide one or more levels of virtualization such as hardware-level virtualization, operating system level virtualization, other virtualization, or a combination thereof. For example, node 200 may provide hardware-level virtualization by running a hypervisor that provides hardware resources to one or more virtual machines. The hypervisor may be one or more programs and may run on a host operating system or a bare-metal hypervisor that may run directly on the hardware. The hypervisor may abstract the physical layer features such as processors, memory, and I/O devices, and present this abstraction as virtual devices to a virtual machine.

As another example, node 200 may provide operating system level virtualization by running a computer program that provides computing resources to one or more containers running on node 200 (e.g., containers 224A, 224b, 224C). The operating system level virtualization may provide resource management features that isolate or limit the impact of one container (e.g., container 224A) on the resources of another container (e.g., container 224B or 224C). The operating system level virtualization may provide a pool of resources that are accessible by container 224A and are isolated from one or more other containers (e.g., container 224B) running on node 200. The pool of resources may include file system resources, network resources (e.g., particular network addresses), memory resources (e.g., particular memory portions), and/or any other computing resources. In one example, node 200 may provide the computing resources to containers 224A-C utilizing an operating system virtualizer, such as Docker for Linux®, ThinApp® by VMWare®, Solaris Zones® by Oracle®, or any other program that automates the packaging, deployment, and execution of applications inside containers.

Each of the containers 224A-C may be and/or include a resource-constrained process space of node 200 that can execute one or more functionalities of a program. Containers 224A-C may be referred to as user-space instances, a virtualization engines (VE), or jails and may appear to a user as a standalone instance of the user space of an operating system. Each of the containers 224A-C may share the same kernel but may be constrained to only use a defined set of computing resources (e.g., CPU, memory, I/O).

In some embodiments, node 200 may host one or more container groups (e.g., container groups 226A and 226B). Each of the container groups may include one or more containers that share computing resources. In some embodiments, container groups 226A and 226B may include data structures for organizing one or more containers 224A-C and enhance sharing between containers, which may reduce the level of isolation between containers within the same container group. Each container group may be associated with a unique identifier, which may be a networking address (e.g., an IP address), that allows applications to use ports without a risk of conflict. A container group may be associated with a pool of resources and may define a volume, such as a local disk directory or a network disk and may expose the volume to one or more of the containers within the container group. In one example, all of the containers associated with a particular container group may be co-located on the same node 200. In another example, the containers associated with a particular container group may be located on different nodes that are on the same or different physical machines. Node 200 can have any suitable number of container groups. Each of the container groups may have any suitable number of containers.

Node 200 can include an agent 222 that can create, start, manage, terminate, delete, etc. one or more of the containers and/or container groups on node 200. Agent 222 can also monitor the resource usage of node 200, containers 224A-C, and/or container groups 226A-B and can transmit data about the resource usage to the scheduler component 142 of FIG. 2. The date about the resource usage may be transmitted to the scheduler component 142 in any suitable interval (e.g., periodically, at random time instances, etc.). In some embodiments, the data about the resource usage may be transmitted to the scheduler component 142 in response to receiving a request for the data from the scheduler component 142.

Agent 222 can relay other information to and from the scheduler component 142 and/or any other component of orchestration system 140. For example, agent 222 can receive commands, manifests, etc. for deploying and/or managing containers and/or container groups on node 200. The commands may include, for example, a command to deploy a container, a command to deploy a container group, a command to execute a job, a command to execute a workload, etc. The manifests may include, for example, a container manifest including properties of a container or a container group (e.g., one or more container images, one or more containers to be deployed, commands to execute on boot of the container(s), ports to enable upon the deployment of the container(s), etc.). In some embodiments, agent 222 can deploy a container and/or a container group on node 200 in view of the commands, manifests, and/or any other data provided by orchestration system 140.

FIG. 3 depicts a block diagram of a computing system 300 operating in accordance with one or more aspects of the present disclosure. Computing system 300 may be and/or include computing system 100 in some embodiments. Computing system 300 may include one or more processing devices and one or more memory devices. In the example shown, computing system 300 may include a scheduler component 142, which may further include a classification module 310, a scheduler module 320, and a resource management module 330.

Classification module 310 may classify nodes of a computing system into one or more into a plurality of node groups. Each of the node groups may be associated with one or more particular container sizes (e.g., a range of container sizes) and designated to host containers and/or container groups of the particular container sizes. M number of nodes.

For example, the node groups may include a first node group designated to host container groups of a first plurality of container sizes, a second node group designated to host container groups of a second plurality of container sizes, a third node group designated to host container groups of a third plurality of container sizes, etc. In some embodiments, the first plurality of container sizes, the second plurality of container sizes, and the third plurality of container sizes may correspond to a first range of container sizes, a second range of container sizes, and a third range of container sizes, respectively. In some embodiments, the nodes may be classified based on computing capacities of the nodes.

In some embodiments, classification module 310 may also classify containers and/or container groups to be deployed in the computing system into a plurality of categories. Each of the categories may correspond to a respective node group (e.g., a class of nodes). For example, the first plurality of container sizes may include the sizes of a first category of containers and/or container groups. As another example, the second plurality of container sizes may include the sizes of a second category of containers and/or container groups.

Scheduler module 320 may schedule deployment of containers and/or container groups on one or more nodes of the computing system. For example, The container groups may be scheduled based on respective sizes of the plurality of container groups and the container sizes associated with the node groups. For example, scheduling a first container group of a first size may involve identifying one or more of the node groups that are designated to host container groups of the first size (e.g., by determining that the first node group is associated with the first plurality of container sizes and that the first plurality of container sizes includes the first size). The processing device may further identify a node of the first node group that is unfilled and may schedule the first container group on the identified node.

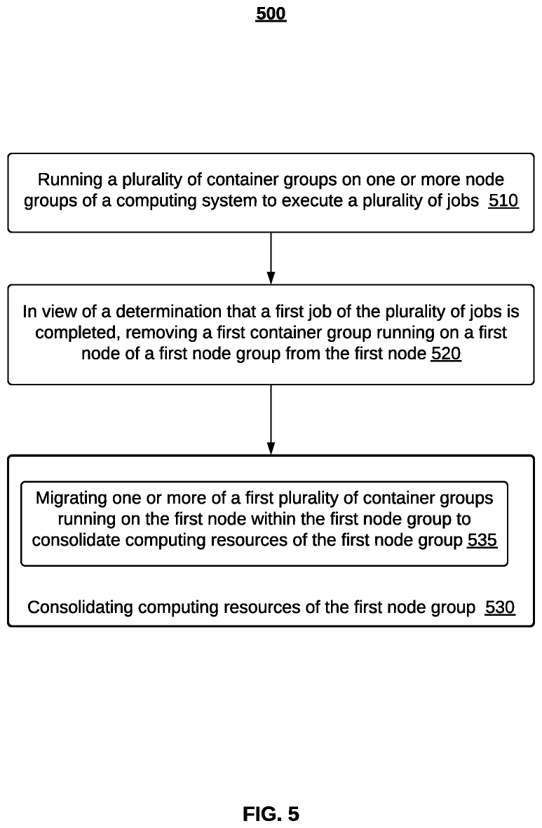

In some embodiments, scheduler module 320 may schedule deployment of the containers and/or container groups based on formulas 1, formulas 2, and/or algorithm 1 as described above. In some embodiments, scheduler module 320 may schedule deployment of the containers and/or container groups by performing one or more operations as described in connection with FIG. 5 below.

Resource management module 330 may monitor and/or manage computing resources of the computing system. For example, resource management module 330 may monitor usages of computing resources by one or more components of the computing system (e.g., nodes, containers, container groups, etc.) and consolidate computing resources allocated to the components. For example, in view of the completion of the first job, resource management module 330 may remove the first container group from the first node. Resource management module 330 may further migrate one or more container groups running on the first node to one or more other nodes of the first node group. In some embodiments, resource management module 330 may perform operations described in conjunction with FIG. 5.

In some embodiments, resource management module 330 may further include a ranking unit 332 and a container migration unit 334.

Ranking unit 332 may rank a plurality of nodes in a node group based on spare capacities of the plurality of nodes. For example, the processing device may rank a first plurality of nodes running on the first node by spare capacity in descending order or ascending order. In some embodiments, ranking unit 332 may sort a plurality of containers and/or container groups running on a node. The containers and/or container groups may be sorted, for example, by computing resource usage in descending order or ascending order.

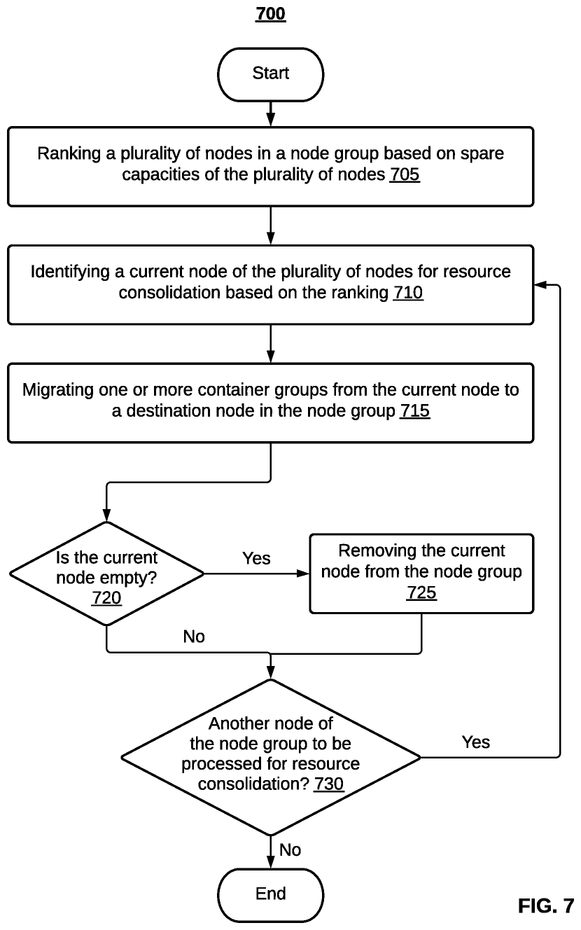

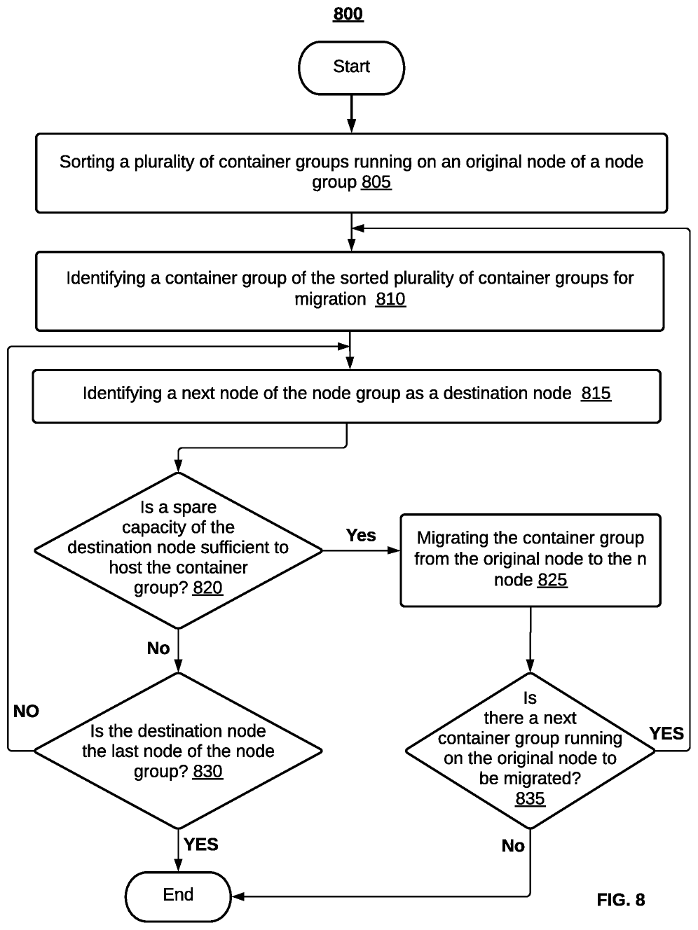

Container migration unit 334 may migrate containers and/or container groups within a node group to consolidate computing resources within the node group and the workloads executed in the computing system. For example, container migration unit 334 may migrate each container group running on the first node to a destination node within the first node group. In some embodiments, container migration unit 334 may determine that one or more container groups running on the first node are not to be migrated in view that no other node in the first node group is unfilled and/or has a spare capacity sufficient to host the container groups. In some embodiments, container migration unit 334 may perform operations as described in connection with FIGS. 7 and 8.

Computing system 300 can also include one or more memory devices storing resource capacity data 352 (e.g., spare capacities of nodes, total capacities of nodes, usages of computing resources by nodes, containers, and/or container groups, etc.). The memory devices can also store image data 354 for deployment of containers and/or container groups for executing workloads in computing system 300. Image data 354 can include any suitable data structure for storing and organizing information that may be used by a node to provide initiate and/or run a container and/or container group. The information within an image of image data 354 may indicate the state of the image and may include executable information (e.g., machine code), configuration information (e.g., settings), or content information (e.g., file data, record data). Each of the images may be capable of being loaded on a node and may be executed to perform one or more computing tasks.

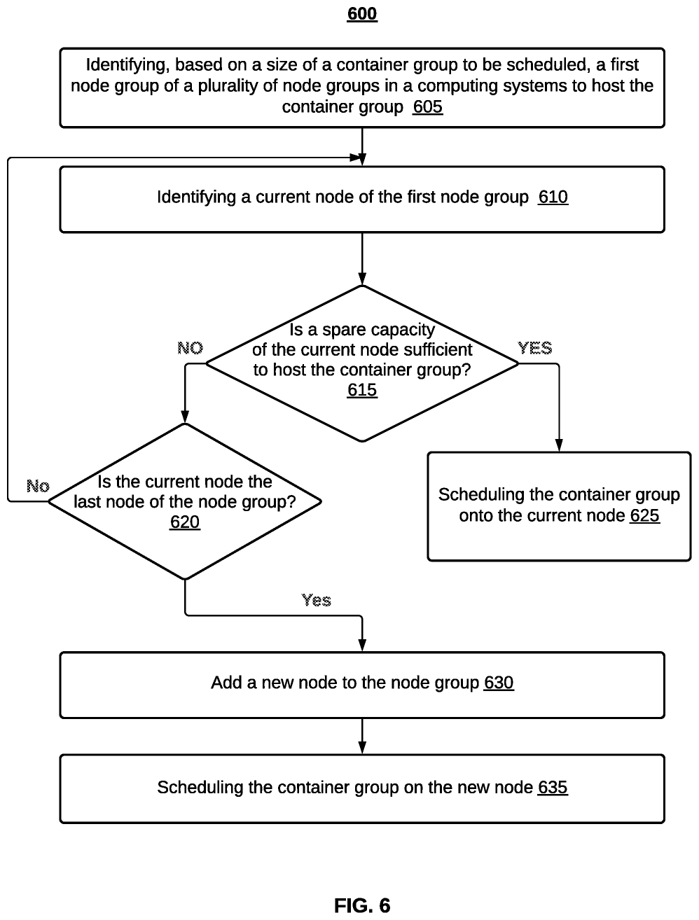

FIG. 4 is a flow diagram illustrating a process 400 for scheduling containers in a computing system according to some implementations of the disclosure. FIG. 5 is a flow diagram illustrating a process 500 for consolidating computing resources for a node group of a computing system according to some implementations of the disclosure. FIG. 6 is a flow diagram illustrating a process 600 for scheduling a container group on a node group in a computer system according to some implementations of the disclosure. FIG. 7 is a flow diagram illustrating a process 700 for consolidating computing resources of a node group in a computing system according to some implementations of the disclosure. FIG. 8 is a flow diagram illustrating a process 800 for migrating a container group from an original node to a destination node according to some implementations of the disclosure.

Processes 400, 500, 600, 700, and 800 can be performed by processing logic that may comprise hardware (e.g., circuitry, dedicated logic, programmable logic, microcode, etc.), software (such as instructions run on a processing device), firmware, or a combination thereof. In some implementations, processes 400, 500, 600, 700, and 800 may be performed by a processing device (e.g., a processing device 902 of FIG. 9) implementing a scheduler component as described in connection with FIGS. 1 and 3.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or memory page media.

Referring to FIG. 4, process 400 may begin at block 410 where the processing device may classify a plurality of nodes of a computing system into one or more node groups. Each of the node groups may be designated to host containers and/or container groups of one or more particular sizes. For example, the node groups may include a first node group designated to host container groups of a first plurality of sizes, a second node group designated to host container groups of a second plurality of sizes, a third node group designated to host container groups of a third plurality of sizes, etc. In some embodiments, the first plurality of sizes, the second plurality of sizes, and the third plurality of sizes may correspond to a first range of container sizes, a second range of container sizes, and a third range of container sizes, respectively. The container sizes may correspond to resource demands of a plurality of jobs. In some embodiments, the nodes may be classified based on computing capacities of the nodes.

At block 420, the processing device may schedule deployment of a plurality of container groups on one or more of the classified nodes. The container groups may be scheduled based on respective sizes of the plurality of container groups and the container sizes associated with the node groups. For example, scheduling a first container group of a first size may involve identifying one or more of the node groups that are designated to host container groups of the first size (e.g., by determining that the first node group is associated with the first plurality of container sizes and that the first plurality of container sizes includes the first size). The processing device may further identify a node of the first node group that is unfilled and may schedule the first container group on the identified node.

In some embodiments, each of the node groups may be associated with a particular range of container group sizes and may be designated to execute jobs and/or container groups associated with a container group size that falls within the range of container group sizes.

In some embodiments, the processing device may schedule the plurality of container groups on one or more of the plurality of nodes based on sizes of the plurality of container groups and the plurality of ranges of container group sizes. More particularly, in view of a determination that a first size of a first container group matches a first range of container group sizes associated with the first node group, the processing device may determine whether the first node is unfilled. The processing device may then schedule the first container group on the first node in response to determining that the first node is unfilled. In some embodiments, determining whether the first node is unfilled comprises determining whether a threshold number of container groups are running on the first node. The threshold may be specified by a user in some embodiments.

In some embodiments, the container groups may be scheduled by performing one or more operations as described in connection with FIG. 6 below.

Referring to FIG. 5, process 500 may begin at block 510 where a plurality of container groups may run on one or more node groups of a computing system. Each of the container groups may include one or more containers sharing one or more computing resources. Each of the container groups may execute one of a plurality of jobs (e.g., jobs relating to one or more workloads). Each of the node groups may include one or more nodes (e.g., nodes 113 of FIG. 1). Each of the node groups may be associated with one or more particular container sizes (e.g., a range of container sizes) and may be designated to host containers and/or container groups of the particular container sizes. For example, the node groups may include a first node group designated to execute containers and/or container groups of a first plurality of container sizes (e.g., a first range of container sizes). As another example, the node groups may include a second node group designated to execute containers and/or container groups of a second plurality of container sizes (e.g., a second range of container sizes). The first plurality of container sizes may or may not overlap the second plurality of container

At block 520, the processing device may determine that a first job of the plurality of jobs is completed. The first job may be executed by a first container running on a first node of a first node group. In view of the completion of the first job, the processing device may remove the first container group from the first node group. Removing the first container group may involve releasing the computing resources of the first node allocated to the first container group.

At block 530, the processing device may consolidate computing resources of the first node groups. The computing resources of the first node group that are to be consolidated at block 530 may include the computing resources of the first node that have been released from the first container group. In some embodiments, consolidating the computing resources of the first node group may involve migrating one or more of a first plurality of container groups within the first node group to consolidate computing resources of the first node group at block 535. For example, the processing device may migrate a second container running on the first node to another node of the first node group (e.g., the destination node). In some embodiments, the processing device may migrate each container group running on the first node to a destination node within the first node group. In some embodiments, the processing device may determine that one or more container groups running on the first node are not to be migrated in view that no other node in the first node group is unfilled and/or has a spare capacity sufficient to host the container groups. In some embodiments, consolidating the computing resources of the first node group may involve performing one or more operations as described in connection with FIGS. 7 and 8.

Referring to FIG. 6, process 600 may begin at block 605 where a processing device may identify a first node group of a plurality of node groups in a computing system to host the container group. Each of the node groups may be associated with one or more particular container sizes (e.g., a certain range of container sizes) and may be designated to host containers and/or container groups of the particular container sizes. The processing device may identify the first node group based on a size of the container group to be scheduled and the container sizes associated with the plurality of node groups. For example, the processing device may determine that a first node group is associated with a first plurality of container sizes (e.g., a first range of container sizes) and that the first plurality of container sizes include the size of the container group to be scheduled (e.g., the size of the container group to be scheduled falls within the first range of container sizes). The processing device may then identify the first node group as a node group that can host the container group to be scheduled.

At block 610, the processing device may identify a current node of the first node group. In some embodiments, the current node may be any suitable node in the first node group. For example, the processing device may identify a node having certain computing resources as the current node. As another example, the processing device may identify a random node as the current node. As still another example, the processing device may identify the current node based on identification numbers associated with the nodes in the first node group.

At block 615, the processing device may determine whether a spare capacity of the current node is sufficient to host the container group. For example, the processing device can determine whether the current node is hosting a threshold number of container groups. More particularly, for example, the processing device may determine that the spare capacity of the current node is not sufficient to host the container group in response to determining that the current node is hosting the threshold number of container groups. Alternatively, the processing device may determine that the spare capacity of the current node is sufficient to host the container group in response to determining that the number of the container groups hosted by the current node is not greater than the threshold number. As another example, the processing device may determine whether an amount of the available computing resources is equal to or greater than the size of the container group to be scheduled. More particularly, for example, the processing device may determine that the spare capacity of the current node is sufficient to host the container group in response to determining that the amount of the available computing resources of the current node is equal to or greater than the size of the container group to be scheduled.

The processing device can proceed to block 625 in response to determining that the current node has sufficient spare capacity to host the container group to be scheduled (“YES” at block 615). At block 625, the processing device may schedule the container group on the current node. For example, the processing device may initiate deployment of the container group on the current node.

In some embodiments, the processing device can proceed to block 620 in response to determining that the spare capacity of the current node is not sufficient to host the container group (“NO” at block 615). At block 620, the processing device may determine whether the current node is the last node of the node group (e.g., the last node to be processed for resource consolidation).

In some embodiments, in response to determining that the current node is not the last node of the node group (“NO” at block 620), the processing device may loop back to block 610 and may identify another node of the first node group as the current node to be processed for resource consolidation. The processing device may identify any suitable node of the first node group that has not been processed for resource consolidation as the current node.

The processing device can proceed to block 630 and add a new node to the node group in response to determining that the current node is the last node of the node group (“YES” at block 620). For example, the processing device may allocate computing resources of a host machine to the new node. At block 635, the processing device may schedule deployment of the container group on the new node.

Referring to FIG. 7, process 700 may begin at block 705 where a processing device may rank a plurality of nodes in a node group based on spare capacities of the plurality of nodes. For example, the processing device may rank a plurality of nodes based on the available computing resources of the plurality of nodes in descending order or ascending order. In some embodiments, the available computing resource may be and/or include storage, processing power, databases, networking, or any other computing resources allocated to the plurality of nodes in the node group. For example, the available computing resources may be and/or include CPU resource.

At block 710, the processing device may identify a current node of the plurality of nodes for resource consolidation based on the ranking. For example, the processing device may identify a node having a particular spare capacity based on the ranking and may designate the identified node as the current node. The identified node may be, for example, a node that has the greatest spared capacity (e.g., the node consuming the least computing resources), a node that has the least spare capacity (e.g., the node consuming the most computing resources), a node that has the second greatest spare capacity, a node that has the second least spare capacity, etc.

At block 715, the processing device may migrate one or more container groups from the current node to a destination node in the node group. The destination node may be any suitable node in the node group. In some embodiments, the spare capacity of the destination node may be greater than the spare capacity of the current node. In some embodiments, migrating one or more container groups from the current node to the next node in the node group may involve performing one or more operations described in connection with FIG. 8.

At block 720, the processing device may determine whether the current node is empty. In some embodiments, the processing device may determine that the current node is empty in response to determining that no container group is hosted by the current node in the computing system.

In some embodiments, in response to determining that the current node is empty, the processing device can proceed to block 725 and may remove the current node from the node group. In some embodiments, removing the current node from the node group may include releasing the computing resources allocated to the current node.

In response to determining that the current node is not empty, the processing device can proceed to block 730 and may determine whether another node of the node group is to be processed for resource consolidation.

In some embodiments, the processing device may loop back to block 710 in response to determining that there is one or more other nodes of the node group to be processed for resource consolidation (“YES” at block 730). For example, the processing device may identify another node of the node group based on the ranking and designate the identified node as the current node to be processed for resource consolidation. The processing device may identify, for example, a node with the second least spare capacity, the second greatest spare capacity, etc.

Referring to FIG. 8, process 800 may begin at block 805 where a processing device may sort a plurality of container groups running on an original node of a node group. The container groups may be sorted, for example, based on computing resource usages of the container groups. For example, the processing device may sort the container groups running on the original node by computing resource usage in descending order or ascending order. The computing resource usages may be and/or include usages of storage resources, usages of processing power (e.g., CPU resource usages), usages of databases, usages of networking resources, etc. As a more particular example, to consolidate resources of the first node group, the processing device may sort a first plurality of container groups running on the first node based on resource usages of the first plurality of container groups.

At block 810, the processing device may identify a container group of the sorted plurality of container groups for migration. For example, the processing device may identify a container group with a certain computing resource usage. The processing device may then designate the identified container group as the container group to be migrated. In some embodiments, the container group to be migrated may include a second container group with the highest computing resource usage, the second highest computing resource usage, the lowest computing resource usage, the second lowest computing resource usage, etc.

At block 815, the processing device may identify a next node of the node group as a destination node. The next node may be any suitable node in the node group. For example, the processing device may randomly select a node of the node group as the destination node. As another example, the processing device may identify a node having a certain spare capacity (e.g., a node having a greater spare capacity than that of the original node) as the destination node. As a more particular example, to migrate a container group running on the first node, the processing device may identify a second node in the first node group as the destination node in view that the second node has a greater spare capacity than the first node. In some embodiments, the second node may be identified by ranking the nodes in the first group by spare capacity.

At block 820, the processing device may determine whether a spare capacity of the destination node is sufficient to host the container group. For example, the processing device can determine whether the destination node is hosting a threshold number of container groups. More particularly, for example, the processing device may determine that the spare capacity of the destination node is not sufficient to host the container group to be migrated in response to determining that the destination node is hosting the threshold number of container groups. Alternatively, the processing device may determine that the spare capacity of the destination node is sufficient to host the container group to be migrated in response to determining that the number of the container groups hosted by the destination node is not greater than the threshold number. As another example, the processing device may determine whether an amount of the available computing resources of the destination node is equal to or greater than the size of the container group to be migrated. More particularly, for example, the processing device may determine that the spare capacity of the destination node is sufficient to host the container group in response to determining that the amount of the available computing resources of the destination node is equal to or greater than the size of the container group to be migrated.

In some embodiments, the processing device can proceed to block 825 in response to determining that the spare capacity of the destination node is sufficient to host the container group (“YES” at block 820). At block 825, the processing device may migrate the container group from the original node to the destination node. For example, the processing device may release the computing resource consumed by the container group in the original node. The processing device may further instruct the original node to stop the container group running on the original node, remove the container group from the original node, start the container group on the destination node (e.g., by instantiating the container group one or more images of the container group), initialize the execution of the job by the container group, etc.

In some embodiments, the processing device can proceed to block 830 in response to determining that the spare capacity of the destination node is not sufficient to host the container group (“NO” at block 820). At block 830, the processing device may determine whether the destination node is the last node of the node group. In some embodiments, the processing device may determine that the destination node is the last node of the node group (e.g., determining that no other node of the node group may host the container group to be migrated). The processing device may then conclude process 800 in view of the determination.

Alternatively, in response to determining that the destination node is not the last node of the node group (“NO” at block 830), the processing device may loop back to block 815 and may identify a next node of the node group as the destination node to which the container group may be migrated. For example, the processing device may identify a third node of the node group as the destination node to which the second container group may be migrated. The third node may have a greater spare capacity than that of the second node and/or the first node. The processing device may then determine whether the spare capacity of the third node is sufficient to host the second container group. In some embodiments, the processing device may migrate the second container group from the first node (the original node) to the third node (the destination node) in response to determining that the spare capacity of the third node is sufficient to host the second container group.

In some embodiments, the processing device may determine whether a next container group running on the original node is to be migrated at block 835. In some embodiments, the processing device can loop back to block 810 in response to determining that one or more container groups of the original node are to be migrated (by determining that the one or more container groups are running on the original node). For example, upon migrating the second container group from the first node to the second node, the processing device may identify a third container group running on the first node as the container group to be migrated. The processing device may then identify a next node of the first node group as a destination node to which the third container group might be migrated. For example, the processing device may identify the second node as the destination node for the migrating the third container group. The processing device may further determine whether the spare capacity of the second node is sufficient to host the third container group. In some embodiments, the processing device may determine that the spare capacity of the second node is sufficient to host the third container group. In view of such determination, the processing device may migrate the third container group from the first node (the original node) to the second node (the destination node). Alternatively, the processing device may determine that the spare capacity of the second node is not sufficient to host the third container group. The processing device may identify a third node of the first node group that has a spare capacity sufficient to host the third container group and may migrate the third container group from the first node (the original node) to the third node (the destination node).

In some embodiments, the processing device may conclude process 800 in response to determining that no other container group is to be migrated (e.g., “NO” at block 835).

FIG. 9 illustrates a diagrammatic representation of a machine in the example form of a computer system 900 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 900 includes a processing device 902 (e.g., processor, CPU, etc.), a main memory 904 (e.g., read-only memory (ROM), flash memory, dynamic random-access memory (DRAM) (such as synchronous DRAM (SDRAM) or DRAM (RDRAM), etc.), a static memory 906 (e.g., flash memory, static random-access memory (SRAM), etc.), and a data storage device 918, which communicate with each other via a bus 908.

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 is configured to execute the processing logic 926 for performing the operations and steps discussed herein.

The computer system 900 may further include a network interface device 922 communicably coupled to a network 974. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 920 (e.g., a speaker).

The data storage device 918 may include a computer-readable medium 924 on which is stored software 926 embodying any one or more of the methodologies of functions described herein. The software 926 may also reside, completely or at least partially, within the main memory 904 as instructions 926 and/or within the processing device 902 as processing logic 926 during execution thereof by the computer system 900, the main memory 904 and the processing device 902 also constituting computer-readable media. The software 926 may further be transmitted or received over a network 974 via the network interface device 922.

The computer-readable medium 924 may also be used to store instructions 926 to manage a plurality of container groups on one or more node groups of a computing system, such as the scheduler component 142 as described with respect to FIGS. 1-3, and/or a software library containing methods that call the above applications. While the computer-readable medium 924 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instruction for execution by the machine and that cause the machine to perform any one or more of the methodologies of the disclosure. The term “computer-readable medium” shall accordingly be taken to include, but not be limited to, solid-state memories, and optical and magnetic media.

In the foregoing description, numerous details are set forth. It will be apparent, however, that the disclosure may be practiced without these specific details. In some instances, well-known structures and devices are shown in block diagram form, rather than in detail, in order to avoid obscuring the disclosure.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “scheduling,” “deploying,” “executing,” “classifying,” “providing,” “determining,” “storing,” “identifying,” “allocating,” “associating,” or the like, refer to the action and processes of a computing system, or similar electronic computing device, that manipulates and transforms data represented as physical (electronic) quantities within the computing system's registers and memories into other data similarly represented as physical quantities within the computing system memories or registers or other such information storage, transmission or display devices.

The terms “first,” “second,” “third,” “fourth,” etc. as used herein are meant as labels to distinguish among different elements and may not necessarily have an ordinal meaning according to their numerical designation.

The disclosure also relates to an apparatus for performing the operations herein. This apparatus may be specially constructed for the purposes, or it may comprise a general purpose computer selectively activated or reconfigured by a computer program stored in the computer. Such a computer program may be stored in a machine readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computing system bus.

The algorithms and displays presented herein are not inherently related to any particular computer or other apparatus. Various general purpose systems may be used with programs in accordance with the teachings herein, or it may prove convenient to construct more specialized apparatus to perform the method steps. The structure for a variety of these systems will appear as set forth in the description below. In addition, the disclosure is not described with reference to any particular programming language. It will be appreciated that a variety of programming languages may be used to implement the teachings of the disclosure as described herein.

The disclosure may be provided as a computer program product, or software, that may include a machine-readable medium having stored thereon instructions, which may be used to program a computing system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method, comprising:
running a plurality of container groups on one or more node groups of a computing system, wherein each of the container groups comprises one or more containers configured to execute one of a plurality of jobs, and wherein the one or more node groups comprise a first node group designated to host container groups of a first plurality of contain sizes and a second node group designated to host container groups of a second plurality of contain sizes;
in view of a determination that a first job of the plurality of jobs is completed, removing, by a processing device, a first container group running on a first node of the first node group from the first node, wherein the first container group is configured to execute the first job; and
migrating, by the processing device, one or more of a first plurality of container groups within the first node group to consolidate computing resources of the first node group.

2. The method of claim 1, wherein migrating one or more of the first plurality of container groups comprises migrating a second container group of the first plurality of container groups from the first node to a second node of the first node group, wherein a spare capacity of the first node is not greater than a spare capacity of the second node.

3. The method of claim 2, wherein migrating the second container group of the first plurality of container groups from the first node to the second node of the first node group comprises:
determining whether the spare capacity of the second node of the first node group is sufficient to host the second container group; and
in response to determining that the spare capacity of the second node is sufficient to host the second container group, migrating the second container group from the first node to the second node.

4. The method of claim 3, wherein determining that the spare capacity of the second node is sufficient to host the second container group comprises determining that the second node is hosting a first number of container groups and that the first number is not greater than a threshold number.

5. The method of claim 3, wherein migrating one or more of the first plurality of container groups comprises:
in response to determining that the spare capacity of the second node is not sufficient to host a third container group of the first plurality of container groups, determining whether a spare capacity of a third node of the first node group is sufficient to host the third container group; and
migrating the third container group from the first node to the third node in response to determining that the spare capacity of the third node is sufficient to host the third container group.

6. The method of claim 2, wherein migrating one or more of the first plurality of container groups within the first node group further comprises:
identifying the second node by ranking a first plurality of nodes of the first node group based on spare capacities of the first plurality of nodes.

7. The method of claim 1, further comprising:
removing the first node from the first node group in response to determining that the first node is empty.

8. The method of claim 1, further comprising:
classifying a plurality of nodes of the computing system into the one or more node groups, wherein each of the node groups is associated with one of a plurality of container sizes; and
scheduling the plurality of container groups on one or more of the plurality of nodes based on sizes of the plurality of container groups and the plurality of container sizes.

9. The method of claim 8, wherein scheduling the plurality of container groups on one or more of the plurality of nodes based on the sizes of the plurality of container groups and the plurality of container sizes comprises:
scheduling the first container group on the first node in view that the first plurality of container sizes comprises a size of the first container group and that the first node is unfilled.

10. The method of claim 1, further comprising adding a new node to the second node group in view that a threshold number of container groups are running on each node of the first node group.

11. The method of claim 1, wherein removing the first container group from the first node of the first node group comprises releasing a first computing resource of the first node allocated to the first container group, and wherein the computing resources of the first node group comprises the released first computing resource.

12. A system comprising:
a memory; and
a processing device operatively coupled to the memory, the processing device to:
run a plurality of container groups on one or more node groups of a computing system, wherein each of the container groups comprises one or more containers configured to execute one of a plurality of jobs, wherein the one or more node groups comprise a first node group designated to host container groups of a first plurality of container sizes and a second node group designated to host container groups of a second plurality of container sizes, and wherein the plurality of container groups comprises a first plurality of container groups running on the first node group;
in view of a determination that a first job of the plurality of jobs is completed, remove, by a processing device, a first container group running on a first node of the first node group from the first node, wherein the first container group is configured to execute the first job; and
migrate one or more of the first plurality of container groups within the first node group to consolidate computing resources of the first node group.

13. The system of claim 12, wherein, to migrate one or more of the first plurality of container groups, the processing device is further to migrate a second container group of the first plurality of container groups from the first node to a second node of the first node group, wherein a spare capacity of the first node is not greater than a spare capacity of the second node.

14. The system of claim 13, wherein to migrate the second container group of the first plurality of container groups from the first node to the second node of the first node group, the processing device is further to: in response to determining that the spare capacity of the second node is sufficient to host the second container group, migrating the second container group from the first node to the second node.

15. The system of claim 14, wherein the processing device is to determine that the spare capacity of the second node is sufficient to host the second container group in response to determining that the second node is hosting a first number of container groups and that the first number is not greater than a threshold number.

16. The system of claim 13, wherein, to migrate one or more of the first plurality of container groups, the processing device is further to:
in response to determining that the spare capacity of the second node is not sufficient to host a third container group of the first plurality of container groups, determine whether a spare capacity of a third node of the first node group is sufficient to host the third container group, wherein the spare capacity of the second node is not greater than the spare capacity of the third node; and
migrate the third container group from the first node to the third node in response to determining that the spare capacity of the third node is sufficient to host the third container group.

17. The system of claim 13, wherein, to migrate one or more of the first plurality of container groups, the processing device is further to:
identify the second node by ranking a first plurality of nodes running on the first node based on spare capacities of the first plurality of nodes; and
sort the first plurality of container groups based on resource usages.

18. The system of claim 12, wherein the processing device is further to:
remove the first node from the first node group in response to determining that the first node is empty.

19. The system of claim 11, wherein the processing device is further to:
classify a plurality of nodes of the computing system into the one or more node groups, wherein each of the node groups is associated with one of a plurality of ranges of container sizes; and
schedule the plurality of container groups on one or more of the plurality of nodes based on sizes of the plurality of container groups and the plurality of ranges of container sizes.

20. A non-transitory machine-readable storage medium including instructions that, when accessed by a processing device, cause the processing device to:
run a plurality of container groups on one or more node groups of a computing system, wherein each of the container groups comprises one or more containers configured to execute one of a plurality of jobs, wherein the one or more node groups comprise a first node group designated to host container groups of a first plurality of container sizes and a second node group designated to host container groups of a second plurality of container sizes, and wherein the plurality of container groups comprises a first plurality of container groups running on the first node group;
in view of a determination that a first job of the plurality of jobs is completed, remove, by a processing device, a first container group running on a first node of the first node group from the first node, wherein the first container group is configured to execute the first job; and
migrate, by the processing device, one or more of the first plurality of container groups within the first node group to consolidate computing resources of the first node group.
